(19) United States
(12) Patent Application Publication
(10) Pub. No.: US 2026/0118608 A1
(43) Pub. Date: Apr. 30, 2026

(54) Optical Module

(71) Applicant: HISENSE BROADBAND MULTIMEDIA TECHNOLOGIES CO., LTD., Qingdao (CN)

(72) Inventors: Fabu XU, Qingdao (CN); Xiangxun SUN, Qingdao (CN); Jinlei CHEN, Qingdao (CN); Huaqiang WANG, Qingdao (CN)

(73) Assignee: HISENSE BROADBAND MULTIMEDIA TECHNOLOGIES CO., LTD., Qingdao (CN)

(21) Appl. No.: 19/004,183

(22) Filed: Dec. 27, 2024

Related U.S. Application Data
(63) Continuation of application No. PCT/CN2023/084080, filed on Mar. 27, 2023.

(30) Foreign Application Priority Data
Jul. 21, 2022 (CN) 202210862361.1
Jul. 21, 2022 (CN) 202221910899.7

(51) Int. Cl. G02B 6/42

(52) U.S. Cl. CPC G02B 6/4261; G02B 6/4278; G02B 6/428

(57) ABSTRACT

An optical module including a lower shell part and an unlocking component. The lower shell part includes first and second lower side plates. The unlocking component includes first and second unlocking portions; a first reed is arranged between the first unlocking portion and the first lower side plate, one end of the first reed being fixedly connected to any one of the first unlocking portion and the first lower side plate, the other end movably connected to any one of the first unlocking portion and the first lower side plate, and central area of the first reed protrudes outwardly and has an open groove; similarly, a second spring is arranged between the second unlocking portion and the second lower side plate, with one end fixedly connected and the other end movably connected, central area of the second spring is protruded outwardly and has an open groove.

### CROSS-REFERENCE TO RELATED APPLICATIONS

This application is a continuation of PCT/CN2023/084080, filed on March 27, 2023, which claims priority to Chinese Application No. 202210862361.1, filed on July 21, 2022, with the China National Intellectual Property Administration (CNIPA); and Chinese Application No. 202221910899.7, filed on July 21, 2022, with the CNIPA, the entire disclosures of which are incorporated herein by reference.

### FIELD

The present disclosure relates to the field of communication technology, and in particular, to an optical module.

### BACKGROUND

With the developments of new services and application models such as cloud computing, mobile internet, and video, the development of optical communication technology has become increasingly important. In the optical communication technology, optical module is one of the key devices in optical communication equipment. In addition, with the development of optical communication technology, the transmission rate of optical module is constantly increasing.

### SUMMARY

The present disclosure provides an optical module, which includes an upper shell part, a lower shell part and an unlocking component. The lower shell part includes a bottom plate and a first lower side plate and a second lower side plate arranged on opposite sides of the bottom plate. The unlocking component comprises a first unlocking portion and a second unlocking portion; a first reed is arranged between the first unlocking portion and the first lower side plate, one end of the first reed is fixedly connected to any one of the first unlocking portion and the first lower side plate, and the other end of the first reed is movably connected to any one of the first unlocking portion and the first lower side plate. A central area of the first reed protrudes in a direction away from the structure where the first reed is located, and the central area of the first reed is provided with an open groove; the second reed is arranged between the second unlocking portion and the second lower side plate, one end of the second reed is fixedly connected to any one of the second unlocking portion and the second lower side plate, and the other end thereof is movably connected to any one of the second unlocking portion and the second lower side plate. A central area of the second reed protrudes away from the structure where the second spring is located, and the central area of the second spring is provided with an open groove, and an extension direction of the open groove is along a length direction of the optical module.

### BRIEF DESCRIPTION OF THE DRAWINGS

The accompanying drawings to be used in some embodiments of the present disclosure will be described briefly below so as to more clearly describe the technical solutions of the present disclosure. Apparently, the accompanying drawings described below are only those of some embodiments of the present disclosure, and for those skilled in the art, other drawings may also be derived from these accompanying drawings. In addition, the accompanying drawings as described below may be regarded as schematic diagrams and are not intended to limit the actual size of the product, the actual process of the method, or the actual timing of the signal involved in the disclosed embodiments.

FIG. 1 is a partial structural diagram of an optical communication system provided according to some embodiments of the present disclosure.

FIG. 2 is a partial structural diagram of a host computer provided according to some embodiments of the present disclosure.

FIG. 3 is a structural diagram of an optical module provided according to some embodiments of the present disclosure.

FIG. 4 is an exploded view of an optical module provided according to some embodiments of the present disclosure.

FIG. 5 is a first structural diagram of a lower shell part provided according to some embodiments of the present disclosure.

FIG. 6 is a second structural diagram of a lower shell part provided according to some embodiments of the present disclosure.

FIG. 7 is a structural diagram of an unlocking component provided according to some embodiments of the present disclosure, which is shown from a first view angle.

FIG. 8 is a schematic structural diagram of an unlocking component provided according to some embodiments of the present disclosure, which is shown from a second view angle.

FIG. 9 is a schematic structural diagram of a first reed provided according to some embodiments of the present disclosure, which is shown from a first view angle.

FIG. 10 is a structural diagram of an unlocking component provided according to some embodiments of the present disclosure, which is shown from a second view angle.

FIG. 11 is a structural diagram of an unlocking component and a lower shell part according to some embodiments of the present disclosure, which is shown from a first view angle.

FIG. 12 is a structural diagram of an unlocking component and a lower shell part provided according to some embodiments of the present disclosure, which is shown from a second view angle.

FIG. 13 is a first structural diagram of an upper shell part provided according to some embodiments of the present disclosure.

FIG. 14 is a second structural diagram of an upper shell part provided according to some embodiments of the present disclosure.

### DETAILED DESCRIPTION

Technical solutions of some embodiments of this disclosure will be described clearly and in detail with reference to the accompanying drawings below. Obviously, these embodiments are merely some, but not all, of the embodiments of this disclosure. All other embodiments obtained by those skilled in the art based on the embodiments of this disclosure fall within the protection scope of this disclosure.

The term “comprise” and other forms thereof such as the third-person singular form “comprises” and the present participle form "comprising" should be construed as open and inclusive, i.e., “including, but not limited to”, throughout the description and the claims unless the context indicates otherwise. In the description, terms such as “one embodiment”, “some embodiments”, “exemplary embodiments”, “example”, “specific example” or “some examples” are intended to indicate that specific features, structures, materials or characteristics related to the embodiment(s) or example(s) are included in at least one embodiment or example of the present disclosure. Schematic representations of the above terms do not necessarily refer to the same embodiment(s) or example(s). In addition, the specific features, structures, materials or characteristics may be included in any one or more embodiments or examples in any suitable manner.

Hereinafter, the terms “first” and “second” are used for descriptive purposes only, and are not to be construed as indicating or implying the relative importance or implicitly indicating the number of indicated technical features. Thus, features defined as “first” and “second” may explicitly or implicitly include one or more of the features. In the description of the embodiments of the present disclosure, the term “a plurality of” means two or more.

In the description of some embodiments, the terms “couple” and “connect” and their extensions may be used. The term "connect" should be understood in a broad sense. For example, "connection" may be a fixed connection, a detachable connection, or an integral connection; it can be directly connected or indirectly connected through an intermediate medium. For example, the term “connect” may be used in the description of some embodiments to indicate that two or more components are in direct or indirect physical or electrical contact with each other. For another example, the term “couple” may be used in the description of some embodiments to indicate that two or more components are in direct or indirect physical or electrical contact. However, the term “coupled” or “communicatively coupled” may also mean that two or more components are not in direct contact with each other, but still cooperate or interact with each other. The embodiments disclosed herein are not necessarily limited to the contents herein.

The phrase “at least one of A, B and C” has the same meaning as the phrase “at least one of A, B or C”, and they both include the following combinations of A, B and C: only A, only B, only C, a combination of A and B, a combination of A and C, a combination of B and C, and a combination of A, B and C.

The phrase “A and/or B” includes the following three combinations: only A, only B, and a combination of A and B.

The use of the phrase “applicable to” or “configured to” herein means an open and inclusive language, which does not exclude devices that are applicable to or configured to perform additional tasks or steps.

The term “about”, “substantially” or “approximately” as used herein includes a stated value and an average value within an acceptable range of deviation of a particular value determined by a person of ordinary skill in the art, considering measurement in question and errors associated with measurement of a particular quantity (i.e., limitations of a measurement system).

As used herein, “parallel”, “perpendicular”, and “equal” include the described situations and situations similar to the described situations, and the range of the similar situations is

within the acceptable range of deviation, wherein the acceptable range of deviation is determined by a person of ordinary skill in the art taking into account the measurement being discussed and the errors associated with the measurement of a particular quantity (i.e., the limitations of the measurement system). For example, “parallel” includes absolute parallelism and approximate parallelism, wherein the acceptable range of deviation of approximate parallelism can be, for example, a deviation within 5°; “perpendicular” includes absolute perpendicularity and approximate perpendicularity, wherein the acceptable deviation range of approximate perpendicularity can also be, for example, a deviation within 5°; “equal” includes absolute equality and approximate equality, wherein the acceptable deviation range of approximate equality can be, for example, the difference between the two equalities is less than or equal to 5% of either one.

Optical communication technology is used to establish information transmission between information processing devices. Optical communication technology loads information onto light and uses the propagation of light to achieve information transmission. The light loaded with information is an optical signal. When an optical signal is propagated in an information transmission device, the loss of optical power may be reduced, and high-speed, long-distance and low-cost information transmission may be achieved. The information that can be processed by an information processing device exists in the form of electrical signal. An optical network terminal/gateway, the router, the switch, the mobile phone, the computer, the server, the tablet and the television are common information processing devices, and the optical fiber and the optical waveguide are common information transmission device.

The mutual conversion of optical and electrical signals between the information processing device and the information transmission device is realized through the optical module. For example, an optical fiber is connected to the optical signal input end and/or the optical signal output end of the optical module, and an optical network terminal is connected to the electrical signal input end and/or the electrical signal output end of the optical module; a first optical signal from the optical fiber is transmitted into the optical module, the optical module converts the first optical signal into a first electrical signal, and transmits the first electrical signal into the optical network terminal; a second electrical signal from the optical network terminal is transmitted into the optical module, the optical module converts the second electrical signal into a second optical signal, and transmits the second optical signal into the optical fiber. Since information processing devices can be connected to each other through an electrical signal network, at least one type of information processing device needs to be directly connected to the optical module, and it is not necessary for all types of information processing devices to be directly connected to the optical module. The information processing device directly connected to the optical module is called a host computer of the optical module.

FIG. 1 is a partial structural diagram of an optical communication system provided according to some embodiments of the present application. As shown in FIG. 1, the optical communication system is partially presented as including a remote information processing device 1000, a local information processing device 2000, a host computer 100, an optical module 200, an optical fiber 101 and a network cable 103.

One end of the optical fiber 101 extends toward the remote information processing device 1000, and the other end thereof is connected to an optical interface of the optical module 200. An optical signal may undergo a total reflection in the optical fiber 101, and propagation of the optical signal in a total reflection direction can almost maintain the original optical power. The optical signal undergoes multiple total reflections in the optical fiber 101, such that the optical signal from the remote information processing device 1000 is transmitted into the optical module 200, or the optical signal from the optical module 200 is transmitted to the remote information processing device 1000, thereby achieving long-distance information transmission with low power loss.

The number of the optical fiber 101 may be one or more (two or more). The optical fiber 101 and the optical module 200 may be connected in a pluggable movable manner or in a fixed manner.

The host computer 100 has an optical module interface 102, which is configured to couple with the optical module 200, such that a unidirectional or bidirectional electrical signal connection is established between the host computer 100 and the optical module 200. The host computer 100 is configured to provide data signals to the optical module 200, or receive data signals from the optical module 200, or monitor and control the working status of the optical module 200.

The host computer 100 has an external electrical interface, such as a Universal Serial Bus (USB) interface and a network cable interface 104, which can be coupled to an electrical signal network. For example, the network cable interface 104 is configured to couple with the network cable 103, thereby establishing a unidirectional/bidirectional electrical signal connection between the host computer 100 and the network cable 103.

Optical Network Unit (ONU), Optical Line Terminal (OLT), Optical Network Terminal (ONT) and data center servers are common host computers.

One end of the network cable 103 is connected to the local information processing device 2000, and the other end thereof is connected to the host computer 100. The network cable 103 establishes an electrical signal connection between the local information processing device 2000 and the host computer 100.

For example, a third electrical signal emitted by the local information processing device 2000 is transmitted to the host computer 100 through the network cable 103; the host computer 100 generates a second electrical signal based on the third electrical signal; the second electrical signal from the host computer 100 is transmitted to the optical module 200; the optical module 200 converts the second electrical signal into a second optical signal, and transmits the second optical signal to the optical fiber 101, and the second optical signal is transmitted to the remote information processing device 1000 through the optical fiber 101.

For example, a first optical signal from the remote information processing device 1000 is propagated through the optical fiber 101; the first optical signal from the optical fiber 101 is transmitted into the optical module 200; the optical module 200 converts the first optical signal into a first electrical signal, and transmits the first electrical signal to the host computer 100; the host computer generates a fourth electrical signal based on the first electrical signal, and transmits the fourth electrical signal to the local information processing device 2000.

The optical module is a tool for achieving the mutual conversion between optical and electrical signals, and during the conversion between optical and electrical signals as described above, the information is not changed, but methods for encoding and decoding the information may be changed.

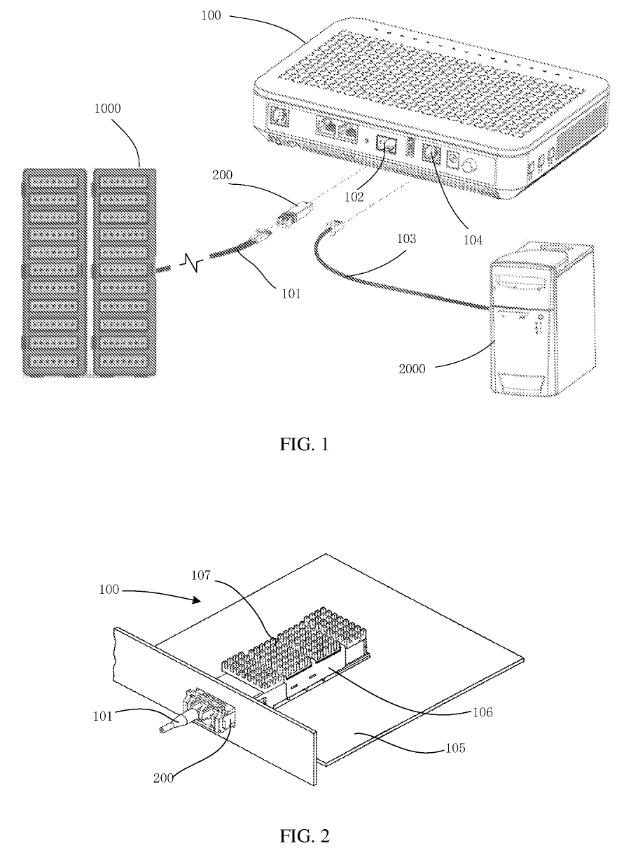

FIG. 2 is a partial structural diagram of a host computer according to some embodiments of this disclosure. In order to illustrate a connection relationship between the optical module 200 and the host computer 100 clearly, FIG. 2 only shows the structure of the host computer 100 related to the optical module 200. As shown in FIG. 2, the host computer 100 further includes a PCB circuit board 105 disposed within a housing, a cage 106 disposed on a surface of the PCB circuit board 105, a radiator 107 disposed on the cage 106, and an electrical connector disposed inside the cage 106 (not shown). The radiator 107 has a raised structure that increases a heat dissipation area. A fin-shaped structure is a common raised structure.

The optical module 200 is inserted into the cage 106 of the host computer 100, and then is secured by the cage 106. Thus, heat generated by the optical module 200 is conducted to the cage 106, and then dissipated via the radiator 107. After the optical module 200 is inserted into the cage 106, an electrical interface of the optical module 200 is connected to the electrical connector inside the cage 106.

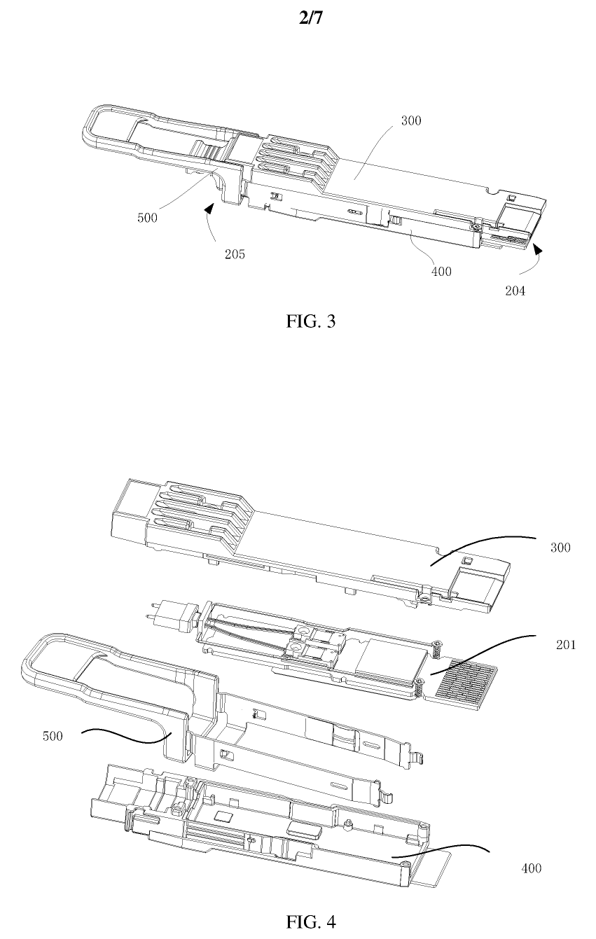

FIG. 3 is a structural diagram of an optical module according to some embodiments of this disclosure, and FIG. 4 is an exploded diagram of an optical module according to some embodiments of this disclosure. As shown in FIG. 3 and FIG. 4, the optical module 200 includes a shell, a circuit board 201, and an optical emission component and/or an optical reception component that are disposed within the shell.

The shell includes a lower shell part 400 and an upper shell part 300 covers on the lower shell part 400 to form the shell with two openings. An outer contour of the shell is generally in a cuboid shape.

In some embodiments of this disclosure, the lower shell part 400 includes a bottom plate and two lower side plates located on opposite sides of the bottom plate and disposed perpendicular to the bottom plate; the upper shell part 300 includes a cover plate covers on the two lower side plates of the lower shell part 400 to form the above mentioned shell.

In some embodiments, the lower shell part 400 includes a bottom plate and two lower side plates located on both sides of the bottom plate and disposed perpendicular to the bottom plate; the upper shell part 300 include a cover plate and two upper side plates located on both sides of the cover plate and disposed perpendicular to the cover plate, and the two upper side plates are combined with the two lower side plates, such that the upper shell part 300 covers the lower shell part 400.

The two openings mentioned above are the first opening 204 and the second opening 205, and a direction of a connecting line between the first opening 204 and the second opening 205 may be the same as a length direction of the optical module 200, or may not be the same as the length direction of the optical module 200. For example, the first opening 204 is located at an end (a right end in FIG. 3) of the optical module 200, and the second opening 205 is also located at an end (a left end in FIG. 3) of the optical module 200. Alternatively, the first opening 204 is located at an end of the optical module 200, and the second opening 205 is located at a side of the optical module 200.

The first opening 204 is an electrical port, and a gold finger of the circuit board 201 extends from the electrical port, and is inserted into the host computer (e.g., the optical network terminal). The second opening 205 is an optical port, which is configured to couple with the external optical fiber 101, such that the optical fiber 101 is coupled to the optical emission component and/or the optical reception component in the optical module 200.

The assembling way in which the upper shell part 300 is combined with the lower shell part 400 facilitates mounting the circuit board 201, the optical emission component and/or the optical reception component or the like into the shell, such that these devices are encapsulated and protected by the upper shell part 300 and the lower shell part 400. In addition, when assembling the circuit board 201, the optical emission component, the optical reception component or the like, it is easier to deploy positioning components, heat dissipation components, and electromagnetic shielding components of these devices, which facilitates automate production implementation.

In some embodiments, the upper shell part 300 and the lower shell part 400 are generally made of metal material(s), which facilitates to achieving electromagnetic shielding and heat dissipation.

In some embodiments, the optical module 200 further includes an unlocking component located outside of the shell thereof, and the unlocking component is configured to achieve or release a fixed connection between the optical module 200 and the host computer.

In an examplary embodiment, an unlocking component 500 is located on outer walls of the two lower side plates of the lower shell part 400, and includes an engagement component that is matched with the cage of the host computer (e.g., the cage 106 of the optical network terminal). When the optical module 200 is inserted into the cage of the host computer, the optical module 200 is fixed in the cage of the host computer via the engagement component of the unlocking component. When the unlocking component is pulled, the engagement component of the unlocking component moves therewith, which in turn changes a connection relationship between the engagement component and the host computer to release the engagement between the optical module 200 and the host computer, such that the optical module 200 can be drawn out of the cage of the host computer.

The circuit board 201 includes circuit wires, electronic elements, chips and the like. The electronic elements and the chips are connected together through the circuit wires according to a circuit design, so as to achieve functions of power supply, electrical signal transmission, grounding and the like. The electronic elements may include, for example, capacitors, resistors, triodes, and metal-oxide-semiconductor field-effect transistors (MOSFETs). The chips may include, for example, a microcontroller unit (MCU), a laser driver chip, a limiting amplifier, a clock and data recovery (CDR) chip, a power management chip, and a digital signal processing (DSP) chip.

The circuit board 201 is generally a rigid circuit board. Also, the rigid circuit board may achieve a carrying function due to its relatively hard material. For example, the rigid circuit board may steadily carry the above-mentioned electronic elements and chips thereon. When the optical reception component and/or the optical emission component are located on the circuit board, the rigid circuit board can also stably carry them. Furthermore, the rigid circuit board may be inserted into the electrical connector inside the cage of the host computer.

The circuit board 201 further includes a gold finger formed on a surface of an end thereof, which is composed of multiple independent pins. The circuit board 201 is inserted into the cage 106 and is conductively connected to the electrical connector inside the cage 106 via the golden finger. The golden finger 301 may be disposed only on a surface of one side of the circuit board 201 (e.g., an upper surface shown in FIG. 4), or on surfaces of upper and lower sides of the circuit board 201 so as to adapt to occasions where a large number of pins are required. The golden finger is configured to establish an electrical connection with the host computer to achieve power supply, grounding, Inter-Integrated Circuit (I2C) signal transmission, data signal transmission or the like.

Of course, it is possible to use a flexible circuit board in some optical modules. The flexible circuit board is generally used in cooperation with the rigid circuit board to serve as a supplement to the rigid circuit board. For example, a flexible circuit board may be used between a rigid circuit board and an optical reception component and/or an optical emission component.

The optical emission component and/or the optical reception component are located at a side of the circuit board 201 away from the golden finger. In some embodiments, the optical emission component and the optical reception component each are physically separated from the circuit board 201, and then electrically connected to the circuit board 201 via a respective flexible circuit board or electrical connector. In some embodiments, the optical emission component and/or the optical reception component may be directly disposed on the circuit board 201, may be disposed on a surface of the circuit board, or be disposed on a side of the circuit board.

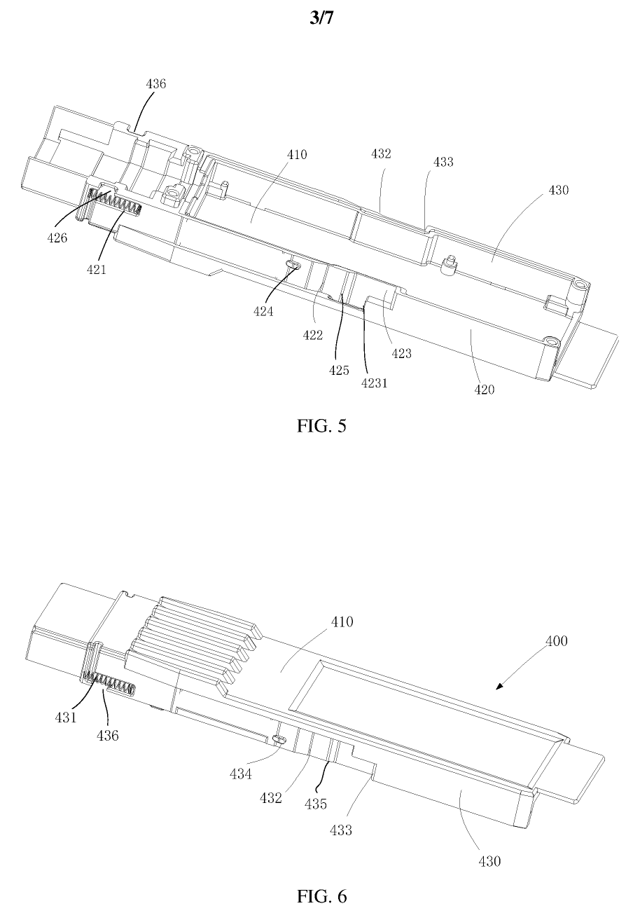

FIG. 5 is a first schematic structural diagram of a lower shell part provided according to some embodiments of the present disclosure; FIG. 6 is a second schematic structural diagram of a lower shell part provided according to some embodiments of the present disclosure. FIG. 5 and FIG. 6 show the lower shell part from different view angles.

As shown in FIG. 5 and FIG. 6, the lower shell part 400 provided according to some embodiments of the present disclosure includes a bottom plate 410, a first lower side plate 420 and a second lower side plate 430. Wherein the first lower side plate 420 is located on one side of the bottom plate 410, and the second lower side plate 430 is located on the other side of the bottom plate 410. A head portion of the first lower side plate 420 is recessed toward the inside of the optical module, and a head portion of the second lower side plate 430 is recessed toward the inside of the optical module, and thus a width of a head portion of the lower shell part 400 is slightly smaller than that of other part of the lower shell part 400. A width of the lower shell part refers to a distance between an inner wall of the first lower side plate 420 and an inner wall of the second lower side plate 430.

As shown in FIG. 5, the head portion of the first lower side plate 420 has a first spring-groove 421 in which a first elastic member is arranged. A middle portion of the first lower side plate 420 has a first groove 422 and a first locking groove 423. The first spring-groove 421, the first groove 422 and the first locking groove 423 are configured to facilitate the assembling of the unlocking component 500. The first groove 422 is configured to engage with a tail portion of the unlocking component 500, and the tail portion of the unlocking component 500 is movable in the first groove 422 during the unlocking process of the optical module. The first locking groove 423 is configured to limit the tail portion of the unlocking component 500 to prevent the unlocking component 500 from moving beyond a limit during the unlocking and locking process of the optical module. The head portion of the first lower side plate 420 is arranged close to the optical port of the optical module, and the tail potion thereof is away from the optical port of the optical module. The first elastic member is retractable along the length direction of the optical module when being subjected to a force.

Wherein, the first elastic member may be a spring.

A first locking protrusion 425 is arranged between the first groove 422 and the first locking groove 423. The first locking protrusion 425 protrudes toward the outside of the first lower side plate 420. A first limiting protrusion 424 is disposed at the other side of the first groove 422, and the first limiting protrusion protrudes toward the outside of the first lower side plate 420. The first limiting protrusion 424 may have a cylindrical shape or other shapes.

As shown in FIG. 6 , the head portion of the second lower side plate 430 has a second spring-groove 431, and a second elastic member is arranged in the second spring-groove 431. A middle portion of the second lower side plate 430 has a second groove 432 and a second locking groove 433. The arrangements of second spring-groove 431, the second groove 432 and the second locking groove 433 makes it easier to assemble the unlocking component 500. The second groove 432 engages with the tail portion of the unlocking component 500, and the tail portion of the unlocking component 500 is movable in the second groove 432 during the unlocking process of the optical module. The second locking groove 433 cooperates to limit the tail portion of the unlocking component 500 to prevent the unlocking component 500 from moving beyond the limit during the unlocking and locking process. The second groove 432 cooperates with the first groove 422, and the second locking groove 433 cooperates with the first locking groove 423, such that the use of the unlocking component 500 is more reliable.

A second locking protrusion 435 is arranged between the second groove 432 and the second locking groove 433. The second locking protrusion 435 protrudes toward the outside of the second lower side plate relative to the second groove 432. A second limiting protrusion 434 is disposed on the other side of the second groove, and the second limiting protrusion 434 protrudes toward the outside of the second lower side plate. The second elastic member is retractable along the length direction of the optical module when being subjected to a force.

The second elastic member may be a spring.

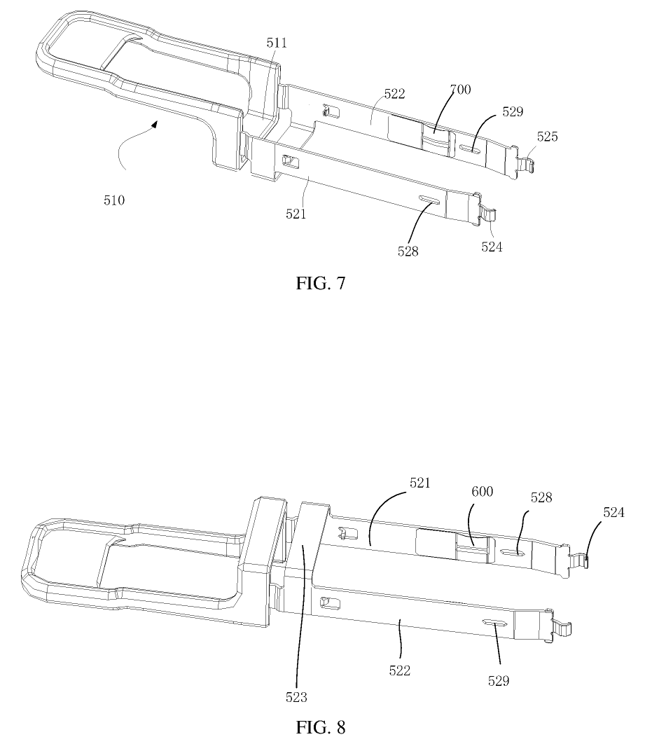

In order to facilitate the assembling and usage reliability of the optical module provided according to the embodiments of the present disclosure, an unlocking component is provided according to the embodiments of the present disclosure. FIG. 7 is a structural diagram of an unlocking component provided according to some embodiments of the present disclosure, which is shown in a first view angle. FIG. 8 is a structural diagram of an unlocking component provided according to some embodiments of the present disclosure shown in a second view angle. FIG. 7 and FIG. 8 show a detailed structure of an unlocking component provided according to the embodiments of the present disclosure.

As shown in FIG. 7 and FIG. 8, the unlocking component 500 provided in the embodiments of the present disclosure includes a handle 510 and an unlocker. The unlocker is connected to the lower shell part 400, and one end of the handle 510 is connected to one end of the unlocker. The handle 510 is configured to facilitate conveniently dragging or pulling the unlocking component 500. When dragging the handle 510, the unlocker can be moved. To facilitate dragging the handle 510, the handle 510 is provided thereon with a first connecting portion 511, through which the handle 510 is connected to the unlocker. The other end of the unlocker has a locking hook, which is configured to connect with the cage in a snap fit manner so as to achieve a mechanical connection between the optical module and the cage.

In some embodiments of the present disclosure, the unlocker includes a first unlocking portion 521 and a second unlocking portion 522. One end of the first unlocking portion 521 is connected to the handle 510, and the other end of the first unlocking portion 521 is connected to and engaged with the first lower side plate 420. When the handle 510 is dragged, the first unlocking portion 521 can be moved along an extension direction of the first lower side plate 420. One end of the second unlocking portion 522 is connected to the handle, and the other end of the second unlocking portion 522 is connected to and engaged to the second lower side plate 430. When the handle 510 is dragged, the second unlocking portion 522 can be moved along the extension direction of the first lower side plate 420. One end of the first unlocking portion 521 and one end of the second unlocking portion 522 are both connected to the first connecting portion 511. When the handle 510 is dragged, the handle 510 drives the first unlocking portion 521 through the first connecting portion 511, such that the first unlocking portion 521 is moved on the first lower side plate 420; and the handle 510 drives the second unlocking portion 522 through the first connecting portion 511, such that the second unlocking portion 522 is moved on the second lower side plate 430.

In the embodiments disclosed herein, the other end of the first unlocking portion 521 has a first locking hook 524, and the first locking hook 524 is configured to realize locking of the first unlocking portion 521 with the cage; one end of the second unlocking portion 522 is also provided with a second locking hook 525, and the second locking hook 525 is configured to realize locking of the second unlocking portion 522 with the cage. The first locking hook 524 in combination with the second locking hook 525 are configured to realize the locking of the optical module with the cage, ensuring the locking firmness of the optical module with the cage. In the process of unlocking the optical module from the cage, the first locking hook 524 and the second locking hook 525 make the unlocking component 500 balanced in force, so as to ensure the service life of the unlocking component 500.

The first unlocking portion 521 has a first limiting hole 528, and the first limiting protrusion 424 is located in the first limiting hole 528. An opening area of the first limiting hole 528 is larger than a cross-sectional area of the first limiting protrusion 424. The cross section of the first limiting protrusion 424 may be circular, elliptical, or rectangular.

The second unlocking portion 522 has a second limiting hole 529, and the second limiting protrusion 434 is located in the second limiting hole 529. An opening area of the second limiting hole 529 is larger than the cross-sectional area of the second limiting protrusion 434. The second limiting protrusion 434 is slidable in the second limiting hole 529.

The first limiting hole 528 functions to limit a position of the first limiting protrusion 424, and the first limiting protrusion 424 is slidable within the first limiting hole 528. The second limiting hole 529 functions to limit a position of the second limiting protrusion 434, and the second limiting protrusion 434 is slidable within the second limiting hole 529.

The unlocking component 500 provided according to the embodiments of the present disclosure further includes a bridge portion 523, one end of the bridge portion 523 is connected to one end of the first unlocking portion 521, and the other end of the bridge portion 523 is connected to one end of the second unlocking portion 522. The bridge portion 523 helps to improve the connection firmness between the handle 510 and the first unlocking portion 521 and the second unlocking portion 522. The first connecting portion 511 is connected to the bridge portion 523.

In the disclosed embodiment, the handle 510 may be an injection molded part, the unlocker may be a sheet metal part, and the bridge portion 523 may be integrally formed with the first unlocking portion 521 and the second unlocking portion 522. To facilitate the connection between the handle 510 and the bridge portion 523 and ensure the firmness of the connection between the handle 510 and the bridge portion 523, the first connection portion 511 is injection molded to wrap the bridge portion 523. The head portions of the first unlocking portion 521 and the second unlocking portion 522 also include several through holes, so as to facilitate tight connection of the first unlocking portion 521 and the second unlocking portion 522 during the injection molding process of the handle 510.

In order to facilitate the unlocking of the unlocking component from the shell of the optical module, a gap is left between the shell of the optical module and an inner wall of the unlocking component. When the optical module is inserted into the cage, reeds inside the cage press the optical module. At this time, the reed of the cage only presses an outer surface of the optical module, and the unlocking component is not pressed against the shell of the optical module. In this case, the gap between the inner side of the unlocking component and the shell of the optical module becomes a leakage path for electromagnetic waves.

In order to reduce electromagnetic wave leakage, a reed is arranged on an inner side of the unlocking component 500, and the reed is located between the unlocking component and the shell of the optical module. The first unlocking portion 521 is disposed with a first reed 600 on the inner wall of the first unlocking portion 521. The first reed 600 is arc-shaped, and a central area of the arc-shaped reed protrudes in a direction away from the structure on which the arc-shaped reed is located, for example, away from the first unlocking portion 521, in other words, the central area of the arc-shaped reed protrudes toward the first lower side plate 420. The first locking hook 524 is disposed at one side of the first limiting hole 528, and the first reed 600 is arranged at the other side of the first limiting hole. A distance between a top of the first reed 600 and the inner wall of the first unlocking portion 521 is 0.3 mm-1.5 mm. If the distance from the top of the first reed 600 to the inner wall of the first unlocking part 521 is less than 0.3 mm, there would be a gap between the unlocker and the shell of the optical module, causing the unlocker and the shell of the optical module not in close contact; if the distance from the top of the first reed 600 to the inner wall of the first unlocking part 521 is greater than 1.5 mm, the outer wall of the first unlocking part 521 would, after being assembled, protrude relative to the shell of the optical module, resulting in poor assembly, poor unlocking, rebound jamming of the unlocking component, or failure of the unlocking component to return to its original position automatically.

One end of the first unlocking portion 521 has a first unlocking check portion 5211 which is located at a left side of the first locking hook 524. A width of the first unlocking check portion 5211 is greater than a width of the first unlocking portion 521. A width of the first locking groove 423 is less than a width of the first groove 422, so there is a first step surface 4231 between the first locking groove 423 and the first groove 422. An end of the first unlocking check portion 5211 is a first reed-reference surface 5212, which can abut against the first step surface to achieve the limiting of the first unlocking portion 521 and the first lower side plate 420.

The first reed 600 is made of a conductive metal material, which may be SUS301 high-rebound stainless steel, and a thickness of the first reed 600 is 0.03-0.07 mm. The thickness of the first reed 600 may be 0.05 mm. The first reed 600 may also be made of glass copper or electroplated nickel to avoid rust caused by external environmental corrosion.

A length between a highest point of the protrusion of the first reed 600 and the reference plane of the first unlocking portion 521 is greater than or equal to 8.9 mm, and is less than or equal to 12.7 mm, such that the arc-shaped area is in close contact with the outer wall of the lower shell part (for example, the first lower side plate 420) of the optical module, to prevent electromagnetic wave leakage and improve the electromagnetic shielding effect of the optical module.

A width of the first reed 600 is equal to or smaller than a width of the first unlocking portion 521, such that the arc-shaped area is in close contact with the lower shell part of the optical module to prevent electromagnetic wave leakage and improve the electromagnetic shielding effect of the optical module.

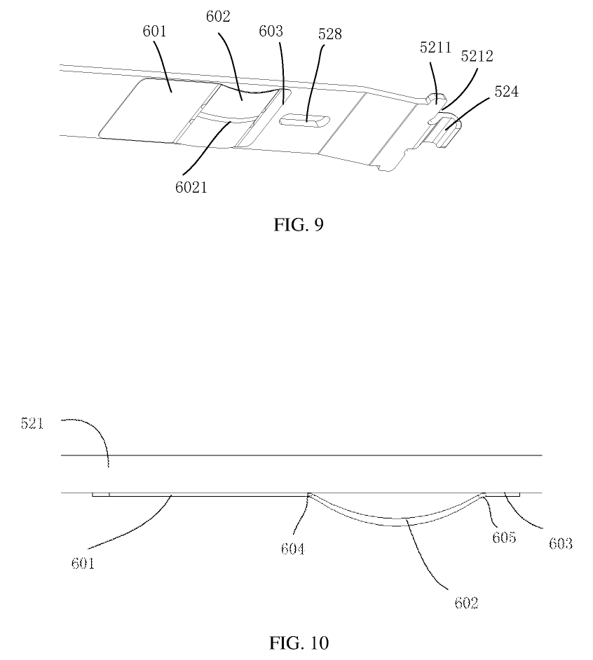

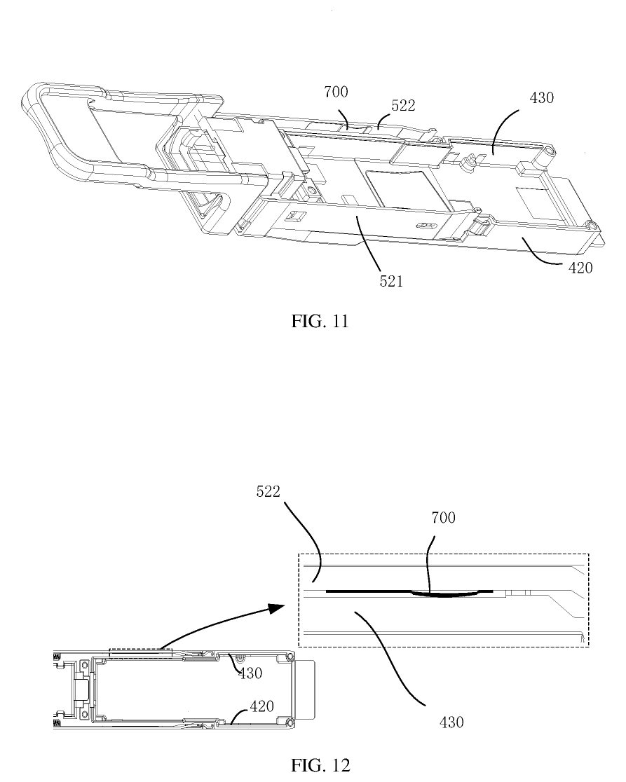

FIG. 9 is a schematic structural diagram of a first reed provided in accordance with some embodiments of the present disclosure shown at a first view angle. FIG. 10 is a schematic structural diagram of an unlocking component provided in accordance with some embodiments of the present disclosure shown at a second view angle. FIG. 11 is a schematic structural diagram of an unlocking component and a lower shell part provided in accordance with some embodiments of the present disclosure, which is shown at a first view angle. FIG. 12 is a schematic structural diagram of an unlocking component and a lower shell part provided in accordance with some embodiments of the present disclosure, which is shown at a second view angle. As shown in FIG. 9, FIG. 10, FIG. 11 and FIG. 12, the first reed 600 includes a first guide portion 601, a first protruding portion 602 and a second guide portion 603. The first guide portion 601 abuts against the inner wall of the first unlocking portion 521 and is fixedly connected to the inner wall of the first unlocking portion 521, the second guide portion 603 abuts against the inner wall of the first unlocking portion 521 and is movably connected to the inner wall of the first unlocking portion 521. The first protruding portion 602 is disposed between the first guide portion 601 and the second guide portion 603, and protrudes in an arc shape toward an opposite side of the first unlocking portion 521. The end of the first guide portion 601 is fixedly connected to the inner wall of the first unlocking portion 521, and the second guide portion 603 is movably connected to the first unlocking portion 521. One end of the first reed 600 is fixedly connected to the first unlocking portion 521, and the other end is not fixed, in such a way that when the first reed 600 is subjected to pressure during the assembling and usage thereof, the unfixed end moves toward the opposite end of the fixed side to release the pressure.

In some embodiments of the present disclosure, the second guide portion 603 is movably connected to the first unlocking portion 521, for example, the second guide portion 603 may abut against the inner wall of the first unlocking portion 521, but is not fixed to the first unlocking portion 521 by a connecting piece; the second guide portion 603 may be connected to the inner wall of the first unlocking portion 521 by a connecting piece, but the position relationship between the second guide portion 603 and the first unlocking portion 521 can change within a certain range; or, there may be a gap between the second guide portion 603 and the inner wall of the first unlocking portion 521.

An area of the first guide portion 601 is larger than that of the second guide portion 603 to increase the connection area between the first reed 600 and the first unlocking portion 521 so as to prevent the first reed 600 from being removed from the first unlocking portion 521 due to excessive friction between the first unlocking portion 521 and the first lower side plate 420.

In a direction from the first guide portion 601 to the first protruding portion 602, the first reed 600 gradually protrudes in a direction away from the inner wall of the first unlocking portion 521. A center position of the first protruding portion 602 along a length of the first protruding portion is the position where the first protruding portion 602 is the largest from the inner wall of the first unlocking portion 521, and is also the position where the first protruding portion 602 is closest to the first lower side plate 420 after the unlocking component is assembled with the lower shell part. From the second guide portion 603 to the first protruding portion 602, the first reed 600 gradually protrudes in a direction away from the inner wall of the first unlocking portion 521. The center position of the first protruding portion 602 along the length thereof is the position where the first protruding portion 602 is the largest from the inner wall of the first unlocking portion 521, and is also the position where the first protruding portion 602 is closest to the first lower side plate 420 after the unlocking component is assembled with the lower shell part.

One side of the second guide portion 603 abuts against the inner wall of the first unlocking portion 521, but is not fixed to the first unlocking portion 521. When the unlocking component is connected to the lower shell part, the first reed 600 is filled between the first unlocking portion 521 and the first lower side plate 420, the first reed 600 is subjected to pressure, causing a protruding distance of the first protruding portion 602 becomes smaller, and the first protruding portion 602 is squeezed to extend towards the second guide portion 603.

One side of the second guide portion 603 abuts against the inner wall of the first unlocking portion 521, such that when the unlocking component and the lower shell part move relative to each other, the first protruding portion 602 extends to be closer to the first unlocking portion 521.

In some embodiments of the present disclosure, the second guide portion 603 may also be fixedly connected to the first unlocking portion 521. The second guide portion 603 and the first unlocking portion 521 may be fixedly connected by welding or gluing.

In order to release pressure and reduce friction between the first unlocking portion 521 and the first lower side plate 420, the central area (that is, the area protruding toward the first lower side plate 420) of the first reed 600 has an open groove. For example, the first protruding portion 602 is formed with an open groove 6021, such that the first protruding portion 602 is easy to deform to release pressure when subjected to a force. An extension direction of the open groove is the length direction of the optical module, and the extension direction of the open groove 6021 is consistent with a sliding direction of the unlocking component in the shell. The open groove 6021 weakens the rigidity of the first protruding portion 602, such that the first protruding portion 602 is easy to deform when subjected to pressure, and the first reed 600 fills the gap between the first unlocking portion 521 and the first lower side plate 420, and prevents the first unlocking portion 521 from protruding outward and deforming.

The first protruding portion 602 may have one open groove 6021, or may have two or more open grooves.

In order to reduce a pressure of the first protruding portion 602 on the first unlocking portion 521 when the first protruding portion 602 is subjected to a pressure, a first transition portion 604 is provided between the first guide portion 601 and the first protruding portion 602, and the first transition portion 604 is arranged obliquely to the first unlocking portion 521. One end of the first transition portion 604 is connected to the first guide portion 601, and the other end of the first transition portion 604 is connected to the first protruding portion 602. In a direction from the first guide portion 601 to the first protruding portion 602, the first transition portion 604 is gradually away from the inner wall of the first unlocking portion 521. The first transition portion 604 is arranged obliquely to the first unlocking portion 521, and an extrusion force suffered by the first protruding portion 602 is decomposed into two components that are perpendicular to the first unlocking portion 521 and parallel to the first unlocking portion 521, thereby reducing the pressure on the first guide portion 601 and reducing the friction between the first guide portion 601 and the first unlocking portion 521, so as to prevent the first unlocking portion 521 and first guide portion 601 from being disengaged.

In order to reduce a pressure of the first protruding portion 602 on the first unlocking portion 521 when the first protruding portion 602 is subjected to a pressure, a second transition portion 605 is provided between the second guide portion 603 and the first protruding portion 602, and the second transition portion 605 is arranged obliquely to the first unlocking portion 521. One end of the second transition portion 605 is connected to the second guide portion 603, and the other end of the second transition portion 605 is connected to the first protruding portion 602. Along a direction from the second guide portion 603 to the first protruding portion 602, the second transition portion is gradually away from the inner wall of the first unlocking portion 521. One end of the second transition portion 605 is arranged obliquely to the first unlocking portion 521, and an extrusion force suffered by the first protruding portion 602 is decomposed into two components that are perpendicular to the first unlocking portion 521 and parallel to the first unlocking portion 521, thereby reducing the pressure on the first guide portion 601 and reducing the friction between the first guide portion 601 and the first unlocking portion 521, so as to prevent the first guide portion 601 from disconnected with the first unlocking portion 521.

The open groove may be set to only penetrate the first protruding portion 602, or may be set to penetrate the first transition portion 604, the first protruding portion 602 and the second transition portion 605. The open groove weakens the rigidity of the first protruding portion 602, such that the first protruding portion 602 is easy to deform under pressure, so that the first reed fills the gap between the first unlocking portion 521 and the first lower side plate 420, and prevents the first unlocking portion 521 from protruding outward and deforming.

A distance between a center of the first reed 600 and a first reed-reference surface is 8.9 mm to 12.7 mm, and the center of the first reed 600 is the center of the first protruding portion 602. For example, the distance between the center of the first reed 600 and the first reed-reference surface is 10.9 mm.

The distance between the top of the first reed and the inner wall of the first unlocking portion is represented by the maximum distance between the first protruding portion and the inner wall of the first unlocking portion.

The second unlocking portion 522 has a second reed 700, which is located on the inner wall of the second unlocking portion 522. The second reed 700 is arc-shaped, and a central area of the arc-shaped reed protrudes in a direction away from the structure on which the arc-shaped reed is located, for example, the arc-shaped reed protrudes in a direction away from the inner wall of the second unlocking portion 522, in other words, the arc-shaped reed protrudes toward the second lower side plate 430. A locking hook is provided at one side of the second limiting hole 529, and the second reed 700 is arranged at the other side of the second limiting hole 529. A distance between a top of the second reed 700 and the inner wall of the second unlocking portion is greater than or equal to 0.3 mm, and the distance between the top of the second reed 700 and the inner wall of the second unlocking portion is less than or equal to 1.5 mm. If the distance from the top of the second reed 700 to the inner wall of the second unlocking portion is less than 0.3 mm, the unlocking component and the shell of the optical module may not be in close contact; if the distance from the top of the second reed 700 to the inner wall of the second unlocking portion 522 is greater than 1.5 mm, the outer wall of the second unlocking portion 522 would protrude relative to the shell of the optical module after being assembled, resulting in poor assembly, poor unlocking, rebound jam of the unlocking component, or failure of the unlocking component to return to its original position automatically.

One end of the second unlocking portion 522 has a second unlocking check portion, which is located at a left side of the second locking hook. A width of the second unlocking check portion is greater than a width of the second unlocking portion 522. A width of the second locking groove is less than a width of the first groove. There is a second step surface between the second locking groove and the second groove. An end of the second unlocking check portion is a second reed-reference surface, which abuts against the second step surface to achieve the limiting of the second unlocking portion 522 and the second lower side plate.

The second reed 700 is made of a metal conductive material. The second reed 700 may be SUS301 high-rebound stainless steel and has a thickness of 0.03-0.07 mm. The thickness of the second reed 700 may be 0.05 mm. The second reed 700 can also be made of glass copper or electroplated nickel to avoid rust caused by external environment corrosion.

A length between a highest point of the protrusion of the second reed 700 and the reference plane of the second unlocking portion is greater than or equal to 8.9 mm, and the length between the highest point of the protrusion of the second reed 700 and the reference plane of the second unlocking portion is less than or equal to 12.7 mm, such that the arc-shaped area is in close contact with the outer wall of the lower shell part (for example, the second lower side plate 430) of the optical module to prevent electromagnetic wave leakage and improve the electromagnetic shielding effect of the optical module.

A width of the second reed 700 is equal to or smaller than a width of the second unlocking portion, such that the arc-shaped area is in close contact with the shell of the optical module to prevent electromagnetic wave leakage and improve the electromagnetic shielding effect of the optical module.

The second reed 700 includes a third guide portion, a second protruding portion and a fourth guide portion. The third guide portion abuts against the inner wall of the second unlocking portion and is fixedly connected to the inner wall of the second unlocking portion. The fourth guide portion abuts against the inner wall of the second unlocking portion and is movably connected to the inner wall of the second unlocking portion. The second protruding portion is arranged between the third guide portion and the fourth guide portion, and protrudes in an arc shape towards the second lower side plate. An end of the third guide portion is fixedly connected to the inner wall of the second unlocking portion, and the fourth guide portion is movably connected to the second unlocking portion. One end of the second reed 700 is fixedly connected to the second unlocking portion, while the other end thereof is not fixed, such that, when the second reed 700 is subjected to pressure during assembling and usage thereof, the unfixed end moves towards the opposite end of the fixed side to release the pressure.

The third guide portion and the inner wall of the second unlocking portion may be fixedly connected by welding or gluing; or the third guide portion and the second lower side plate may be integrally formed.

An area of the third guide portion is greater than that of the fourth guide portion to increase the connection area between the second reed 700 and the second unlocking portion so as to avoid the second reed 700 from being disengaged from the second unlocking portion due to excessive friction between the second unlocking portion and the second lower side plate.

Along a direction from the third guide portion to the second protruding portion, the second reed 700 gradually protrudes in a direction protruding from the inner wall of the second unlocking portion. A center position of the second protruding portion along a length of the second protruding portion is the position where the second protruding portion is farthest from the inner wall of the second unlocking portion, and is also the position where the second protruding portion is closest to the second lower side plate after the unlocking component is assembled with the lower shell part. Along a direction from the fourth guide portion towards the second protruding portion, the second reed 700 gradually protrudes towards the direction protruding from the inner wall of the second unlocking portion, and the center position of the second protruding portion along its length is the position where the second protruding portion is farthest from the inner wall of the second unlocking portion, and is also the position where the second protruding portion is closest to the second lower side plate after the unlocking component is assembled with the lower shell part.

One side of the fourth guide portion abuts against the inner wall of the second unlocking portion, but the fourth guide portion is not fixedly connected to the second unlocking portion. When the unlocking component is connected to the lower shell part, the second reed 700 is filled between the second unlocking portion and the second lower side plate, the second spring 700 is subjected to a pressure, causing a protruding distance of the second protruding portion becomes smaller, and the second protruding portion is squeezed to extend towards the fourth guide portion.

In some examples, the central area (that is, the area protruding toward the second lower side plate 430) of the second reed 700 may be provided with an open groove, and an extension direction of the open groove of the second reed 700 is the same as the length direction of the optical module, and the extension direction of the open groove is consistent with a sliding direction of the unlocking component on the shell.

In an examplary embodiment, the open groove is formed on the second protruding portion. For example, the second protruding portion may have one open groove, or two or more open grooves. A length from the center of the second reed 700 to the second reed-reference surface is greater than or equal to 8.9 mm, and is less than or equal to 12.7 mm. The center of the second reed 700 is the center of the second protruding portion. For example, the length from the center of the second reed 700 to the second reed-reference surface is 10.9 mm.

In some embodiments of the present disclosure, the first reed 600 and the second reed 700 are symmetrically arranged at opposite sides of the lower shell part, which can ensure that the unlocking component undergoes uniform stresses and avoid deformation of the unlocking component due to uneven stress, which otherwise would cause the unlocking component unable to return to its original position automatically.

The unlocking component, when being pulled, suffers a pressure from an engagement part in the cage, and the first reed 600 and the second reed 700 are extended towards their unfixed ends, respectively, to release pressure, thereby reducing the friction between the unlocking component and the lower shell part. After installation, the first reed 600 is located in the gap between the first unlocking portion 521 and the first lower side plate 420, and the second reed 700 is located in the gap between the second unlocking portion and the second lower side plate, which is beneficial to avoid electromagnetic wave leakage of the optical module and improve the electromagnetic shielding effect of the optical module.

In some embodiments of the present disclosure, the first reed 600 and the second reed 700 may also be arranged on outer sides of the shell of the optical module, and the first reed 600 and the second reed 700 may both be fixedly connected to the lower shell part of the optical module. The first reed 600 is connected to the first lower side plate 420, but not to the first unlocking portion 521. The first reed 600 includes the first guide portion 601, the first protruding portion 602, and the second guide portion 603. Wherein the first guide portion 601 is fixedly connected to the first lower side plate 420; and the first protruding portion 602 is arc-shaped and is protruded toward an area away from the first lower side plate 420, in other word, the first protruding portion 602 protrudes toward the first unlocking portion 521. The first protruding portion 602 is filled between the first lower side plate 420 and the first unlocking portion 521 to prevent electromagnetic waves inside the optical module from leaking to the outside of the optical module, and to prevent electromagnetic waves outside the optical module from entering into the optical module.

The second guide portion 603 may be fixedly connected to the first lower side plate 420, or may not be fixedly connected to the first lower side plate 420. The second guide portion and the first lower side plate 420 may be fixedly connected by welding, or the second guide portion and the first lower side plate 420 may be integrally formed. When the first reed 600 is subjected to a squeezing force from the first unlocking portion 521, the protruding portion of the first reed 600 is deformed to reduce a force on the first lower side plate.

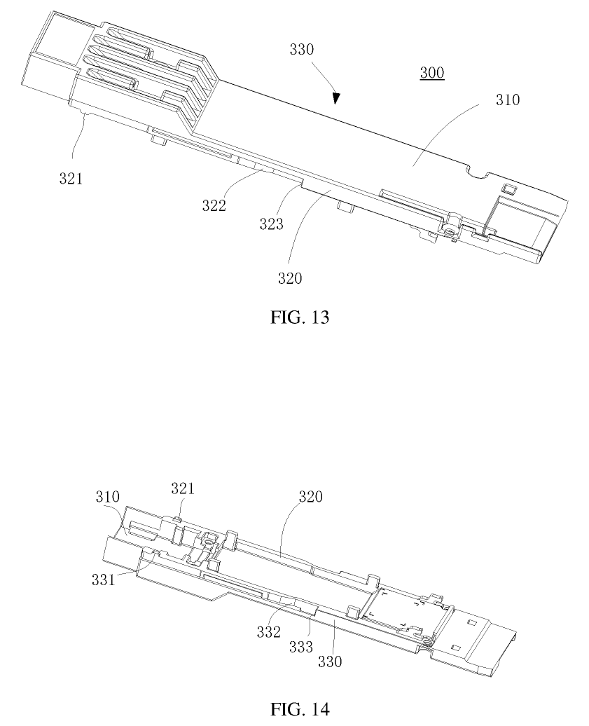

The second reed 700 is connected to the second lower side plate, but not to the second unlocking portion. The second reed is filled between the second lower side plate and the first unlocking portion to prevent electromagnetic waves inside the optical module from leaking to the outside of the optical module, and to prevent electromagnetic waves outside the optical module from entering the optical module. FIG. 13 is a first structural diagram of an upper shell part provided according to some embodiments of the present disclosure, and FIG. 14 is a second structural diagram of an upper shell part provided according to some embodiments of the present disclosure. FIG. 13 and FIG. 14 show basic structure of an upper shell part provided according to an embodiment of the present disclosure.

The upper shell part 300 provided in the embodiments of the present disclosure includes a cover plate 310, a first upper side plate 320 and a second upper side plate 330. In this embodiment, in order to prevent the spring from being ejected from the spring-groove under force during the unlocking process, a first raised portion 321 is provided at a head portion of the first upper side plate, and the first raised portion 321 is arranged to be corresponded to a first notch 426 on the first lower side plate. A second raised portion is provided at a head portion of the second upper side plate, and the second raised portion 331 is arranged to be corresponded to a second notch 436. When the upper shell 300 and the lower shell 400 are assembled, the first raised portion 321 is embedded in the first notch, and the second raised portion 331 is embedded in the second notch, thereby sealing the first elastic member in the first spring-groove and sealing the second elastic member in the second spring-groove, so as to prevent the elastic members from falling out of the spring-grooves under force.

The first notch is communicated with the first spring-groove, and the second notch is communicated with the second spring-groove.

When the upper shell and the lower shell are assembled, the first raised portion is embedded in the first notch, and the second raised portion is embedded in the second notch, thereby sealing the first elastic member and the second elastic member in the first spring-groove and the second spring-groove, respectively, to prevent the elastic members from falling out of the spring-grooves when subjecting to forces.

In some embodiments of the present disclosure, an upper side edge of the first unlocking portion 521 is higher relative to a side edge of the first lower side plate 420, and an upper side edge of the second unlocking portion 522 is higher relative to a side edge of the second lower side plate 430. The first upper side plate also has a third groove 322 and a third locking groove 323, and the second upper side plate also has a fourth groove 332 and a fourth locking groove 333. The third groove 322 and the fourth groove 332 are respectively connected to the unlocking component 500. The tail portion of the unlocking component 500 can move in the third groove 322 and the fourth groove 332 during the unlocking process of the optical module; and the third locking groove 323 and the fourth locking groove 333 act to limit the unlocking component 500 to prevent the unlocking component 500 from moving beyond the limit during the unlocking and locking process of the optical module.

To facilitate sliding movement between the unlocking component and the shell, the width of the first unlocking portion 521 is less than or equal to a sum of widths of the first groove and the third groove, and a width of the second unlocking portion is less than or equal to a sum of widths of the second groove and the fourth groove.

Finally, it should be noted that the above embodiments are only provided to illustrate the technical solutions of the present disclosure, rather than to limit them. Although the present disclosure has been described in detail with reference to the aforementioned embodiments, those skilled in the art should understand that they can still modify the technical solutions described in the aforementioned embodiments, or make equivalent replacements for some of their technical features. However, these modifications or replacements do not deviate the essence of the corresponding technical solution from the spirit and scope of the technical solutions of the embodiments of the present disclosure.

1. An optical module, comprising:
an upper shell part;
a lower shell part, which comprises a bottom plate, a first lower side plate and a second lower side plate, wherein the first lower side plate and the second lower side plate are respectively arranged on opposite sides of the bottom plate; and
an unlocking component, which comprises:
a first unlocking portion located at an outer side of the first lower side plate,
a second unlocking portion located at an outer side of the second lower side plate,
a first reed arranged between the first unlocking portion and the first lower side plate, one end of the first reed being fixedly connected to any one of the first unlocking portion and the first lower side plate, and the other end of the first reed being movably connected to any one of the first unlocking portion and the first lower side plate, and
a second reed arranged between the second unlocking portion and the second lower side plate, one end of the second reed is fixedly connected to any one of the second unlocking portion and the second lower side plate, and the other end of the second reed is movably connected to any one of the second unlocking portion and the second lower side plate; and
wherein, a central area of the first reed protrudes away from a structure on which the first reed is located, and the central area of the first reed has an open groove; a central area of the second reed protrudes away from a structure on which the second reed is located, and the central area of the second reed has an open groove; and extension directions of the open grooves are along a length direction of the optical module.

2. The optical module according to claim 1, wherein a width of the first reed is less than or equal to a width of the first unlocking portion; and a width of the second reed is smaller than or equal to a width of the second unlocking portion.

3. The optical module according to claim 1, wherein the central area of the first reed is in an arc shape; the central area of the second reed is in an arc shape; and the first reed and the second reed are symmetrically arranged.

4. The optical module according to claim 1, wherein
the first reed is arranged on an inner wall of the first unlocking portion, one end of the first reed being fixedly connected to the first unlocking portion, the other end of the first reed being movably connected to the first unlocking portion, and the central area of the first reed protruding toward the first lower side plate; and
the second reed is arranged on an inner wall of the second unlocking portion, one end of the second reed being fixedly connected to the second unlocking portion, the other end of the second reed being movably connected to the second unlocking portion, and the central area of the second reed protruding toward the second lower side plate.

5. The optical module according to claim 4, wherein
the first reed comprises a first guide portion, a first protruding portion and a second guide portion, wherein one end of the first guide portion is fixedly connected to the inner wall of the first unlocking portion, and the other end of the first guide portion is connected to the first protruding portion; one end of the second guide portion is connected to the first protruding portion, and the other end of the second guide portion abuts on the inner wall of the first unlocking portion; the first protruding portion protrudes toward the first lower side plate; and the open groove is provided on the first protruding portion;
the second reed comprises a third guide portion, a second protruding portion and a fourth guide portion, wherein one end of the third guide portion is fixedly connected to the inner wall of the second unlocking portion, and the other end of the third guide portion is connected to the second protruding portion; one end of the fourth guide portion is connected to the second protruding portion, and the other end of the fourth guide portion abuts on the inner wall of the second unlocking portion; the second protruding portion protrudes toward the second lower side plate; and the open groove is arranged on the second protruding portion.

6. The optical module according to claim 5, wherein the first reed further comprises a first transition portion and a second transition portion, wherein
the first transition portion is located between the first guide portion and the first protruding portion, and the first transition portion is inclined relative to the first unlocking portion and is gradually distanced from the inner wall of the first unlocking portion along a direction from the first guide portion to the first protruding portion; and
the second transition portion is located between the second guide portion and the first protruding portion, and the second transition portion is inclined relative to the first unlocking portion and is gradually distanced from the inner wall of the first unlocking portion along a direction from the second guide portion to the first protruding portion.

7. The optical module according to claim 6, wherein the open groove on the first reed runs through the first protruding portion, the first transition portion and the second transition portion.

8. The optical module according to claim 1, wherein a number of the open groove is one or more.

9. The optical module according to claim 1, wherein a thickness of each of the first reed and the second reed is 0.03 mm to 0.07 mm.

10. The optical module according to claim 1, wherein the first reed and the second reed are both metal conductive members.

11. The optical module according to claim 1, wherein
the first lower side plate comprises a first groove and a first locking groove, wherein the first groove is configured to cooperate with a tail portion of the first unlocking portion, and the tail portion of the first unlocking portion moves in the first groove during unlocking process of the optical module; the first locking groove is configured to limit the tail portion of the first unlocking portion;
a first step surface is provided between the first groove and the first locking groove; and
the tail portion of the first unlocking portion is connected to a first locking hook, a first reed-reference surface is arranged between the first unlocking portion and the first locking hook, and the first reed-reference surface abuts on the first step surface.

12. The optical module according to claim 11, wherein a distance between a center of the first reed and the first reed-reference surface is greater than or equal to 8.9 mm, and the distance between the center of the first reed and the first reed-reference surface is less than or equal to 12.7 mm.

13. The optical module according to claim 4, wherein a distance between a center of the first reed and the inner wall of the first unlocking portion is greater than or equal to 0.3 mm, and the distance between the center of the first reed and the inner wall of the first unlocking portion is less than or equal to 1.5 mm.

14. The optical module according to claim 11, wherein
the second lower side plate comprises a second groove and a second locking groove, wherein the second groove is configured to cooperate with a tail portion of the second unlocking portion, and the tail portion of the second unlocking portion moves in the second groove during unlocking process of the optical module; and the second locking groove is configured to limit the tail portion of the second unlocking portion;
a second step surface is provided between the second groove and the second locking groove; and
the tail portion of the second unlocking portion is connected to a second locking hook, a second reed-reference surface is arranged between the second unlocking portion and the second locking hook, and the second reed-reference surface abuts on the second step surface.

15. The optical module according to claim 14, wherein a distance between a center of the second reed and the second reed-reference surface is greater than or equal to 8.9 mm, and the distance between the center of the second reed and the second reed-reference surface is less than or equal to 12.7 mm.

16. The optical module according to claim 14, wherein a first upper side plate of the upper shell part comprises a third groove and a third locking groove, and a second upper side plate of the upper shell part comprises a fourth groove and a fourth locking groove, wherein
the third groove is configured to cooperate with the tail portion of the first unlocking portion, the third locking groove is configured to limit the tail portion of the first unlocking portion, and the tail portion of the first unlocking portion moves in the first groove and the third groove during the unlocking process of the optical module; and
the fourth groove is configured to cooperate with the tail portion of the second unlocking part, the fourth locking groove is configured to limit the tail portion of the second unlocking portion, and the tail portion of the second unlocking part moves in the second groove and the fourth groove during the unlocking process of the optical module.

17. The optical module according to claim 16, wherein a width of the first unlocking portion is smaller than or equal to a sum of widths of the first groove and the third groove, and a width of the second unlocking portion is smaller than or equal to a sum of widths of the second groove and the fourth groove.

18. The optical module according to claim 1, wherein the first reed is arranged on an outer wall of the first lower side plate, and wherein one end of the first reed is fixedly connected to the first lower side plate, the other end of the first reed is movably connected to the first lower side plate, and the first reed protrudes toward the first unlocking portion; and
the second reed is arranged on an outer wall of the second lower side plate, and wherein one end of the second reed is fixedly connected to the second lower side plate, the other end of the second reed is movably connected to the first lower side plate, and the second reed protrudes toward the second unlocking portion.

19. The optical module according to claim 1, wherein the first unlocking portion has a first limiting hole; the first lower side plate has a first limiting protrusion matching with the first limiting hole; and the first limiting protrusion is placed in the first limiting hole.

20. The optical module according to claim 19, wherein the first limiting hole is arranged between the first reed and a first locking hook at a tail portion of the first unlocking portion, and a cross-sectional area of the first limiting hole is greater than a cross-sectional area of the first limiting protrusion.
